(19) United States
(12) Patent Application Publication
(10) Pub. No.: US 2021/0081928 A1
(43) Pub. Date: Mar. 18, 2021

(54) SYSTEMS AND METHODS FOR LINKING DEVICES TO USER ACCOUNTS

(71) Applicant: Samsung Electronics Co., Ltd., Suwon-si (KR)

(72) Inventors: Enyang Huang, Andover, MA (US); William Wang Graylin, Winchester, MA (US)

(21) Appl. No.: 17/105,874

(22) Filed: Nov. 27, 2020

Related U.S. Application Data
(63) Continuation of application No. 14/286,248, filed on May 23, 2014.

(51) Int. Cl. G06Q 20/36; G06F 21/44; H04L 9/32; G06Q 20/34; G06Q 20/40

(52) U.S. Cl. CPC G06Q 20/363; G06F 21/445; G06F 2221/2103; G06Q 20/34; G06Q 20/4012; H04L 9/3271

(57) ABSTRACT

A device, system and method for uniquely binding a MST to a user account to load and securely store a magnetic stripe card data for transmission to a merchant's point of sale (POS) terminal, checkout system, or other MSR device. The system provides a convenient buying experience for buyers, and secure and informative transactions for sellers.

### CROSS-REFERENCE TO RELATED APPLICATION(S)

This application is a continuation application of prior application Ser. No. 14/286,248, filed on May 23, 2014, the disclosure of which is incorporated by reference herein in its entirety.

### FIELD

The present disclosure relates to magnetic stripe storage and transmission devices.

### BACKGROUND

Transmission of magnetic stripe data has been done primarily by swiping a magnetic stripe card against a magnetic stripe reader (MSR) to enable payment, identification (ID), and access control functions. Mobile wallet applications on smartphones and tablets have had difficulty interacting with existing merchant point of sale (POS) devices or other devices with MSRs. Contactless reader enabled POS terminals (typically using, for example, an ISO 14443 standard) are not ubiquitous to accept contactless or near field communications (NFC) payments. It would be expensive and would take time to replace the millions of merchant POS devices or door locks that only accept magnetic stripe cards, just to interact with NFC phones or other transmission means like barcodes.

### SUMMARY

The present disclosure relates to devices, systems, and methods including a magnetic stripe storage and transmission device (also referred to as a magnetic stripe transporter (MST)) for use in conjunction with a mobile wallet application to capture, store and transmit magnetic stripe card data to merchants' conventional point of sale (POS) terminals and other devices with magnetic stripe readers (MSRs) or checkout systems, in physical and virtual environments. The devices, systems, and methods provide secure binding, linking, or pairing of the MST to a user account. In one aspect, this unique binding of the MST to a specific user account provides increased security.

### BRIEF DESCRIPTION OF THE DRAWINGS

Embodiments of devices, systems, and methods are illustrated in the figures of the accompanying drawings which are meant to be exemplary and not limiting, in which like references are intended to refer to like or corresponding parts, and in which:

FIG. 1 is a functional diagram of an overview of a binding of a MST to a user account;

FIG. 2 is a flow diagram of a method of operation of initializing the MST and checking the MST's binding status;

FIG. 3 is a flow diagram of a method of binding the MST to a user account;

FIG. 4 is a flow diagram of another method of binding the MST to a user account; and

FIG. 5 is a functional block diagram of the MST.

### DETAILED DESCRIPTION

Detailed embodiments of devices, systems, and methods are disclosed herein, however, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative basis for teaching one skilled in the art to variously employ the present disclosure.

Generally, the devices, systems, and methods disclosed herein can include, and may be implemented, within a number of different devices and computer systems, including, for example, general-purpose computing systems, server-client computing systems, consumer-merchant computing systems, mainframe computing systems, a cloud computing infrastructure, telephone computing systems, laptop computers, desktop computers, smartphones, cellular phones, personal digital assistants (PDAs), tablet computers, and other mobile devices. The devices and computing systems may have one or more databases and other storage apparatuses, servers, and additional components, for example, processors, modems, terminals and displays, computer-readable media, algorithms, modules and applications, and other computer-related components. The devices and computer systems and/or computing infrastructures are configured, programmed, and adapted to perform the functions and processes of the systems and methods as disclosed herein.

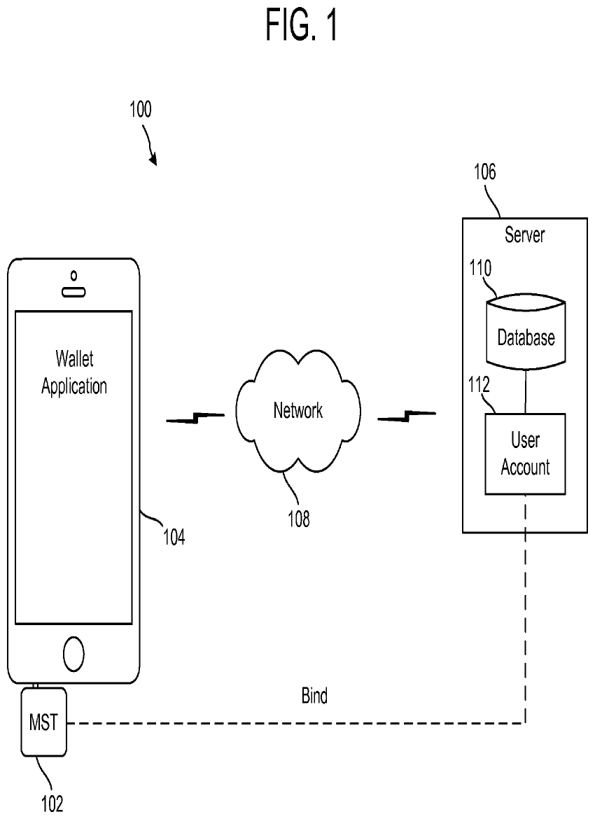

An overview of a system 100 for binding a MST to a user account according to an illustrative embodiment is described with reference to FIG. 1. The system 100 includes a MST 102, a mobile communication device 104, and a server 106. The MST 102 is adapted to interface with the mobile communication device 104, and the mobile communication device 104 communicates with the server 106 via a network 108. The server 106 may include one or more databases 110 and user accounts 112. The one or more databases 110 may store association data of the MST 102 and user account 112, and one or more keys used by the MST 102 and/or the server 106. The MST 102 may be bound with the user account 112, as described in further detail below (it should be appreciated that the terms binding and pairing are used interchangeably herein).

As illustrated, the MST 102 may be a dongle that may be connected to and disconnected from the mobile communication device 104. The MST 102 may communicate with the mobile communication device 104 through an audio port and/or through other types of communication interfaces, for example including, but not limited to, a USB port, a 30 pin or 9 pin Apple interface, a Bluetooth interface, a near field communication (NFC), and other serial interfaces. While the MST 102 is illustrated as a dongle, the MST may be another type of peripheral device that communicates with the mobile communication device 104 through a contactless interface, such as Bluetooth or NFC.

In an aspect, a user may set-up the user account 112 on the server 106, for example, by downloading and/or installing a wallet application in the mobile communication device 104. The user may also set-up a user account 112 using a computer connected to the network 108 by accessing a user account web portal. To set up the user account 112, the user may specify a user name, password and a personal PIN. The password may be used to login to the wallet application on the mobile communication device 104. Once the user is logged in, the personal PIN may be used to enter a payment card section of the wallet application, authenticate with the MST 102, as well as to unlock the wallet application.

The user may optionally add the MST 102 to the user account 112 by specifying a globally unique identifier (GUID) of the MST 102 (also referred to herein as ID_{MST}). If the GUID specified by the user is valid and is “occupied,” meaning it is currently added under another user account, then it cannot be accepted under the user account 112. If the GUID is valid and not occupied, meaning it is not currently bound with a user account, the server 106 may generate a provisioning token or “binding token.” The provisioning token includes the personal PIN and is backed by the authority of the server. The provisioning token may then be securely injected to the MST 102 when the wallet application next communicates with the server 106. The personal PIN can be seen as a shared secret between the MST 102 and the user, allowing authentication to operate the MST 102 to be performed in the absence of server connectivity. The PIN (which only the user knows) is used to authenticate with the MST 102 to operate any card data stored on the MST 102. A copy of the PIN may also be stored on the server 106 and used as described below. Operation of the MST 102 using the PIN-based authentication can be done with or without the mobile communication device 104 being connected to the server 106 via the network 108. This allows the MST 102 to be operated to utilize the card data stored on the MST 102, even when no network connection exists.

Each MST 102 may be initially open to be bound with a user account 112. Once the MST 102 is bound, the MST 102 may be locked and have to be unlocked to change modes and parameters on the MST 102. The MST 102 can store cardholder data by either an initial load at manufacturing, loading via a wireless communication network after setting up the user account 112, and/or by the consumer loading his/her own card(s) data directly into the MST 102 using the mobile wallet application. In general, the user is a person that has set up a user account, for example, on the server 106 via a cloud computing infrastructure (such as via the network 108), and has initialized the wallet application on his/her mobile communication device 104.

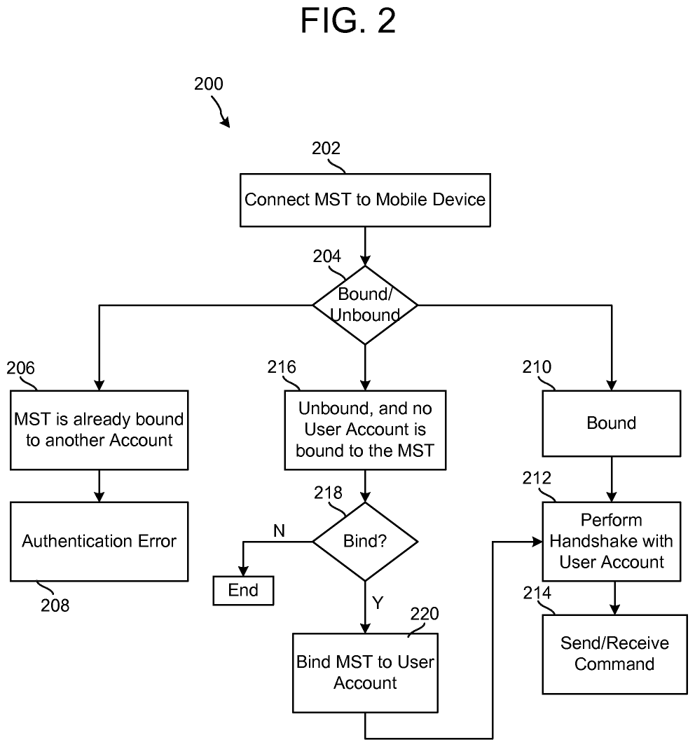

A method 200 of initializing and binding the MST 102 to a user account 112 according to an illustrative embodiment is described with reference to FIG. 2. An MST is initialized for the first time to a user account by plugging in or connecting the MST to the mobile communication device, illustrated as block 202. Upon connecting the MST to the mobile communication device, the wallet application recognizes or determines the status of the MST as bound and unbound, illustrated as block 204.

When the MST dongle has already been bound to another user account, the wallet application will recognize the MST as bound to another user account, illustrated as block 206, and generate an authentication error, illustrated as block 208.

When the MST has been bound to the appropriate user account, the wallet application recognizes the MST as bound, illustrated as block 210. The MST and the user account may then perform a handshake, illustrated as 212, and send and receive commands, illustrated as block 214.

When the MST has not been bound and there is no user account bound to the MST, upon connecting the MST to the mobile communication device, for example, a smartphone with the wallet application thereon, the wallet application recognizes the MST as unbound, illustrated as block 216. The wallet application may then face a determination as to whether the MST should be bound to the user account, illustrated as block 218. If the appropriate user account user desires to bind the MST, a binding process begins and the MST is bound to the user account, illustrated as block 220. Upon binding the MST to the user account, the MST and the user account may then perform a handshake, illustrated as 212, and send and receive commands, illustrated as block 214.

Once the MST has been bound with the user account, the user can use the wallet application to load his/her cards by swiping the cards on a built in magnetic stripe reader (MSR) of the MST or a separate MSR that may be connected to the MST or the mobile communication device. The card data may be digitized and encrypted, and stored into the memory means or secure element of the MST for later use.

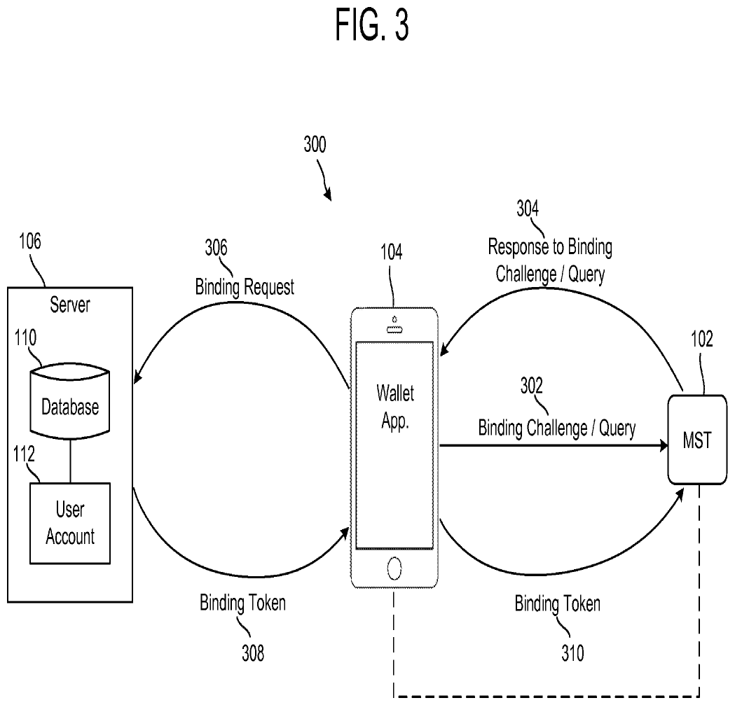

A method 300 of paring the MST 102 to the user account 112 according to an illustrative embodiment is described with reference to FIG. 3. As illustrated, upon connecting the MST 102 to the mobile communication device 104 operating the wallet application, the wallet application sends a binding challenge or query to the MST 102, illustrated as 302. The MST 102 responds to the binding challenge/query by sending a response, illustrated as 304, to the wallet application on the mobile communication device 104. The wallet application on the mobile communication device 104 then sends a binding request, illustrated as 306, to the server 106. The server 106 may authenticate the MST 102 and the request. The server 106 may then send a binding token, illustrated as 308, to the wallet application on the mobile communication device 104 to bind the MST to the user account 112. The wallet application on the mobile communication device 104 forwards the binding token to the MST 102, illustrated as 310.

In an embodiment, the MST 102 contains an ID_{MST} (such as 16-byte non-predictable ID) and a key K_{MST} (such as a 16-byte key) stored in memory. In this embodiment, the server 106 is capable of generating K_{MST} given the ID_{MST}. The K_{MST} is then a shared secret between the server 106 and the MST 102. Each MST may have a different K_{MST} and ID_{MST} for security purposes.

The MST 102 and server 106 communicate indirectly via the wallet application on the mobile communication device 104. The communications between the server 106 and the mobile communication device 104 may be secured using SSL3/TLS. Communications between the MST 102 and the mobile communication device 104 may be encrypted using a session key Kₛₑₛₛᵢₒₙ derived from the personal PIN and session random nonce.

In this embodiment, the mobile communication device 104 sends the binding challenge (302), including an indication to initiate binding (for example a random number or other type of initiation indication). The response to the binding challenge/query (304) sent from the MST 102 to the mobile communication device 104 includes the ID_{MST} and a random number R_{MST} (also referred to as a nonce) generated by the MST. The binding request (306), with input from the user includes the user's username, password, and the ID_{MST} and R_{MST} generated by the MST. The server 106 authenticates the user with the user account 112 using the username and password. The server 106 then checks to see if the received ID_{MST} is valid and that the MST 102 is currently not bound to any other user account. The server 106 computes K_{MST} using the ID_{MST}, and sends back a binding token (308) signed using K_{MST}. The binding token may include R_{MST}, a server generated time-stamp R_{S}, the PIN, and may also include some auxiliary information, such as a verification component that will have to be transported along with the signature in order for it to be verifiable by the MST 102. The wallet application on the mobile communication device 104 forwards this binding token to the MST 102 (310). The MST verifies the binding token using the key K_{MST} and matches R_{MST}. If everything looks fine, the MST installs the PIN. At this moment, the MST is said to be bound or bound to the user account 112, and the user can operate the MST using the personal PIN.

In this embodiment, the handshake (illustrated as block 212 in FIG. 2) may be performed by the wallet application first sending an Exchange Nonce (EN) command to the MST 102 along with a random challenge R_{W}¹ generated by the wallet application. The MST 102, upon receiving the message, generates and returns a random nonce R_{MST}¹. The MST 102 also echoes EN, by sending EN back to the wallet application. At this stage, both the wallet application and the MST 102 know the other's fresh nonce. During subsequent communications, the sender always acknowledges the receiver's nonce as part of the message payload. The purpose of the handshake for exchanging nonce can be seen as an effort to defray any replay attacks. The counter-party's nonce is in service until another handshake is performed, for example, until the wallet application sends the next EN message. There may also be a life-span associated with each handshake, and the MST 102 and/or the wallet application may request a new handshake if a previous handshake has expired.

After the handshake is complete, both the wallet application and the MST 102 are ready to send and receive commands (illustrated as block 214 in FIG. 2). The authentication is performed on a per message basis; that is, the sender must demonstrate its knowledge of the shared secret, in this case, this is the personal PIN that the user specified during set-up of the user account. A command CMD may be sent from the wallet application to the MST 102 by sending the CMD and R_{MST}¹ signed using the PIN or a derivation of the PIN. Similarly, subsequent messages in the other direction (the MST 102 to the wallet application) are sent by sending the CMD and R_{W}¹ signed using the PIN. The use of the combination of the PIN and nonce ensure proper authentication and defense against replay for both parties. However, the protocol may still be susceptible to replay attack within a same handshake session. Therefore, a counter may be included in the CMD within a session. The sender may then increment the counter every time a new CMD is sent, and the receiver may check the counter to verify whether the counter is monotonically increasing.

In another embodiment, the server 106 stores a public-private key bind (K_{S} and K_{S}⁻¹). The server 106 may generate, for example, a self-signed certificate (Cert_{S}), a root certificate, intermediate certificate, signing certificate, etc. This certificate is used to verify certificate chain locally at the wallet application and the MST 102. The wallet application associated with the user account 112 also has a public-private key bind (K_{W} and K_{W}⁻¹). The private key is stored in a password-protected keystore or a keychain. The public key, user account ID and optionally some auxiliary information (used for verification purposes) are sent to the server 106 for certification. The wallet application securely possesses its identity certificate Cert_{W}, which is signed by server 106, and the wallet application securely possesses Cert_{S} in a trusted store. The MST 102 also has a public-private key bind (K_{MST} and K_{MST}⁻¹) generated at manufacturing. The MST 102 possesses its identity certificate Cert_{MST} and Cert_{S}, both assigned and installed at manufacturing.

Using the certificates and keys described above, the wallet application on the mobile communication device 104 can obtain the binding status of the MST 102 without the need for a network connection. To perform this function, the wallet application detects that the MST 102 is connected to the mobile communication device 104. The wallet application generates a random challenge R_{W} (such as, a time-stamp and a random number) and sends it to the MST 102. In response, the MST 102 generates a random challenge R_{MST}. The combination of R_{W} and R_{MST} represent a mutually-verifiable fresh nonce, and the MST 102 signs it with K_{MST}⁻¹. The MST 102 sends R_{MST}, the signature and its identity certificate Cert_{MST} to the wallet application.

The wallet application knows R_{W} and its freshness and can thus verify the signature as newly computed by the MST 102, thereby ruling out replay attack. Moreover, the wallet application can authenticate the MST 102 from the signature. If everything verifies, the wallet application generates a session key Kₛₑₛₛᵢₒₙ and a random sequence number Seq_{W} and then signs [R_{W}, R_{MST}, Kₛₑₛₛᵢₒₙ, and Seq_{W}]. The resulting signature and the wallet application's identity certificate Cert_{W} is sent to the MST 102. The MST is then able to authenticate the wallet application. The secrecy of the session key is guarded by the encryption using the MST's public key. At this stage, the MST 102 checks its internal state and answers if it is ready to perform new binding or it is currently bound with a user account.

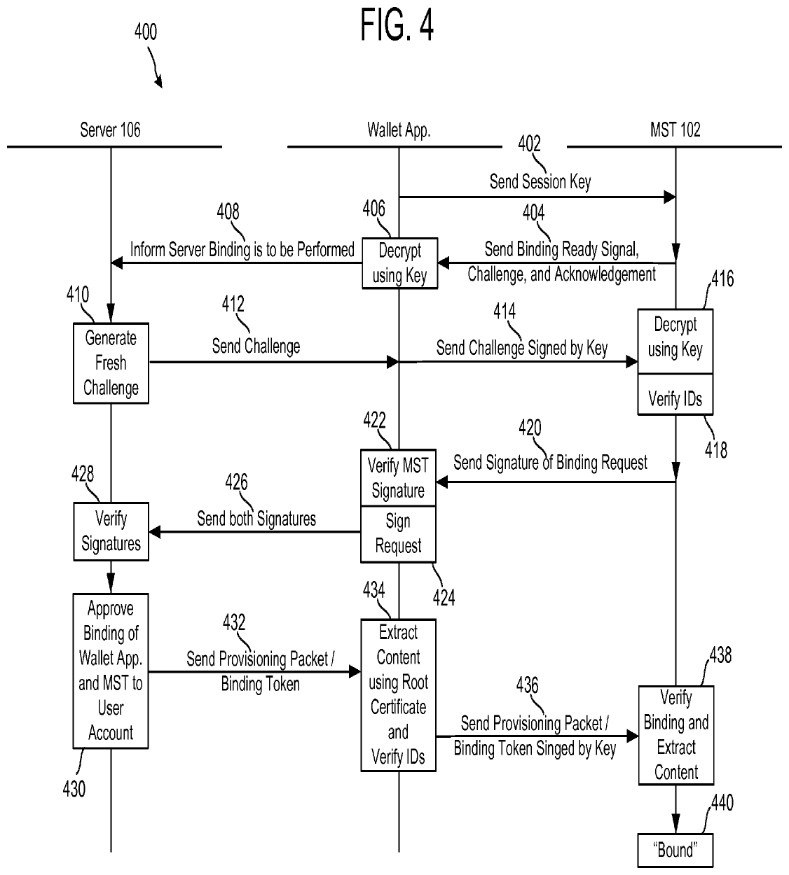

In this embodiment, a method 400 for performing a new binding is described with reference to FIG. 4. The wallet application sends the session key Kₛₑₛₛᵢₒₙ to the MST 102 (402). The MST 102 sends a binding ready signal (modeled as a constant PR) as well as a challenge [R_{W}, R_{MST}] and acknowledgement of the receipt of the session key Kₛₑₛₛᵢₒₙ to the wallet application (404). From this moment, the wallet application and the MST 102 use the session key Kₛₑₛₛᵢₒₙ. The wallet application decrypts the response from the MST 102 (404) using Kₛₑₛₛᵢₒₙ and obtains the MST state constant PR (406). The wallet application first informs the server 106 that a binding is to be performed (408); this intention is encoded with a constant pairing signing request (PSR), as well as the certificates of the MST 102 and the wallet application (Cert_{W}, Cert_{MST}). Upon receiving PSR, the server 106 generates a fresh challenge R_{S} (including a server timestamp, ID_{W} and ID_{MST}) (410) and sends the challenge to the wallet application (412).

The wallet application does not need to authenticate R_{S} since the transmission is over an SSL/TLS (RFC6101/RFC2246) session. The wallet application passes along R_{S}, together with R_{MST}, and the PSR message to the MST 102 signed by Kₛₑₛₛᵢₒₙ (414). The MST 102 decrypts the message using Kₛₑₛₛᵢₒₙ (416). The MST 102 can therefore assert that the message is from the wallet application and verify its freshness from R_{MST}. The MST 102 also verifies that the IDs inside R_{S} are itself and the wallet application (418). The MST 102 returns its signature of the request and therefore expresses its willingness to perform binding with the user account (420). The MST 102 returns R_{S} and PSR signed by K_{MST}⁻¹, all signed by Kₛₑₛₛᵢₒₙ to the wallet application. The wallet application verifies that the message is signed by the MST 102 with Cert_{MST} (422). The wallet application also signs the same inner content, resulting in R_{S} and PSR signed by K_{W}⁻¹ and thereby expresses its willingness to perform binding (424). Finally, the wallet application returns both signatures (R_{S} and PSR signed by K_{MST}⁻¹, and R_{S} and PSR signed by K_{W}⁻¹) to the server 106 over the secure channel (426).

The server 106 verifies with Cert_{W} and Cert_{MST} and recognizes the freshness of this signing request from R_{S} (428). The server 106 then performs a signing over R_{S} and effectively approves binding of the wallet application and the MST 102 to the user account 112, with a time-stamp signified from within R_{S} (R_{S} signed by K_{S}⁻¹) (430). The server 106 then sends this provisioning packet to the wallet application (432). The server 106 also saves the cryptogram ({R_{S}, PSR, Cert_{W}, Cert_{MST}, {R_{S}, PSR} K_{MST}⁻¹, {R_{S}, PSR} K_{W}⁻¹}) as evidence of issuing the provisioning packet or token (308).

The wallet application extracts the content using the root certificate Cert_{S} and verifies that ID_{W} and ID_{MST} are correct (434). If all are correct, the wallet application forwards the provisioning packet or token ({{R_{S}} K_{S}⁻¹} Kₛₑₛₛᵢₒₙ) to the MST 102 (436). The wallet application saves the cryptograms ({{R_{S}} K_{S}⁻¹, Cert_{MST}}) as a record for the binding. The MST 102 verifies the binding and extracts the content with root certificate Cert_{S} (438). The MST 102 then verifies that ID_{MST} is itself and ID_{W} is the correct user account associated with the wallet application. At this stage, it promotes its internal state to “bound” (440). The MST 102 also saves the cryptograms ({{R_{S}} K_{S}⁻¹, Cert_{W}}) for later handshakes with the same user account.

In this embodiment, the handshake (illustrated as block 212 in FIG. 2) may be performed as described below. The MST 102 is currently bound with a user account. The MST 102 compares the Cert_{W} it received (after authenticating the wallet account and/or the wallet application) and a wallet account ID from its stored provisioning packet {R_{S}} K_{S}⁻¹ that it received as described above. If the two match, the MST 102 sends a handshake complete signal (modeled as a constant “HC”), a randomly generated sequence number Seq_{MST} as well as the challenge {R_{W}, R_{MST}} and its acknowledgement of receipt of session key Kₛₑₛₛᵢₒₙ. From this moment, the wallet application and the MST 102 switch to using session key Kₛₑₛₛᵢₒₙ.

The wallet application reads the cipher text, decrypts and sees R_{W} so it understands the freshness of the message. The wallet application also sees HC, so it knows that the MST 102 has accepted the handshake. Finally, the wallet application compares the identity ID_{MST} with the one from R_{S} described above, if the two match, the wallet application promotes its internal state to handshake complete.

After the handshake is complete, both the wallet application and the MST 102 are ready to send and receive commands (illustrated as block 212 in FIG. 2). The combination of the session key (described above) and randomly generated sequence numbers from both parties are used to ensure proper security during this operation. Before sending/receiving any commands, both the wallet application and the MST 102 possess its own and know the other's sequence number. Seqⁱ denotes the sequence number of a principal (in this case either the wallet application or the MST 102) prior to its (i+1)^{th} message transmission as a sender. Thus initially Seq⁰_{W}=Seq_{W} and Seq⁰_{MST}=Seq_{MST}. Where Seq_{W} and Seq_{MST} are sequence numbers as described above. Additionally, a deterministic function f that is known to both the wallet application and the MST 102 is defined, for either the wallet application or the MST 102 and the i^{th} sequence number Seqⁱ: f(Seqⁱ)=Seqⁱ⁺¹.

The message protocol and enforcement constraints are as follows: suppose at some stage principal X (i.e. the MST or the wallet application) has sent i number of commands to principal Y (i.e., the other of the MST or the wallet application) and the principal Y has sent j number of commands to principal X, and suppose that X is now sending the (i+1)^{th} command to the Y. The format of the message may be: X→Y: {Seq^{j}_{Y}, Seqⁱ⁺¹_{X}, CMD} Kₛₑₛₛᵢₒₙ, assuming without loss of generality that X received Seq^{j}_{Y}. Where, CMD is the specific command that X is sending to Y. Y decrypts the message using session key Kₛₑₛₛᵢₒₙ. Y compares Seq^{j}_{Y} with its currently stored sequence number, and takes the latest sequence number of X that Y received (which is Seqⁱ_{X}) and verifies that with Seqⁱ⁺¹_{X}. The combination of the session key (described above) and the sequence numbers from both parties are used to ensure proper security during this operation.

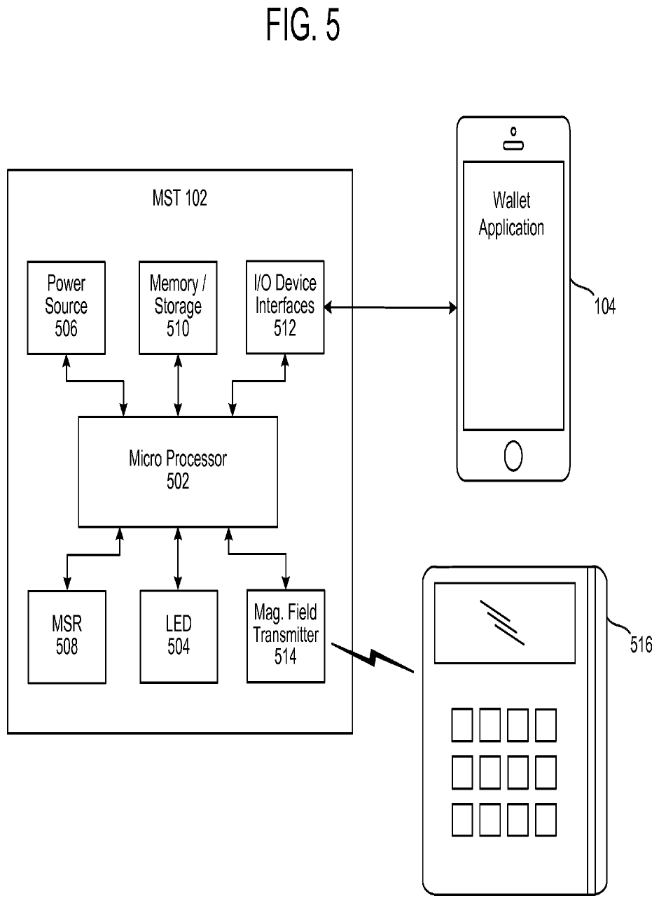

Once the MST 102 is bound with the user account 112, the MST 102 can be used to interact with a merchant point of sale (POS) by transmitting magnetic stripe data from a magnetic field transmitter to a magnetic stripe reader (MSR) of the merchant POS. As illustrated in FIG. 5, the MST 102 includes a microprocessor 502, a light-emitting diode (LED) indicator 504, a power source 506, optionally a magnetic stripe reader (MSR) 508, a memory storage component or secure element 510, an input/output interface 512 (for example, a 3.5 mm or other standard audio port, a USB port/jack interface or other communication interface, including but not limited to a 30 pin or 9 pin Apple interface, a Bluetooth interface, and other serial interfaces), and a magnetic field transmitter 514 which includes a driver and an inductor for transmitting magnetic pulses to be received by any POS device with a MSR, such as the POS 516.

Microprocessor 502 handles security and communications with the mobile communication device 104. The microprocessor 502 can also transmit and receive encrypted card data to and from the secure element 510. The magnetic field transmitter 514 transmits magnetic stripe data of a cardholder to the POS device 516 by transmitting magnetic impulses to the MSR of the POS device 516. The MST 102 may also be used for reading other magnetic stripe cards by using the optional MSR 508. The MSR 508 may be used for loading payment card data onto the secure element 510 and for capturing card track data.

The mobile communication device 102 includes the wallet application, and may also include a display with key pad or touchpad display and a central processing unit (CPU). The wallet application initializes and unlocks the MST 102, interacts with the MST 102 and accepts card payment data from the MST 102.

The card data may be encrypted, and the encrypted data may be transmitted to the mobile communication device 104. The wallet application may transmit the data to the server. The data may be decrypted at the server and the primary account number (PAN) data, card number, expiration and name of the cardholder is stripped from the track data. The wallet application or the server may also make a determination as to whether the magnetic card is a payment card or a non-payment card. If the magnetic card is a non-payment card the MST 102 can automatically store the track data in the memory for non-payment transmission. If the magnetic card is a payment card, for example, having a specific format recognizable to the system, the card may be detected as a payment card and the system determines if the name on the payment card matches the name of the user account. If the name does not match, an error message may arise. If the name on the payment card matches the name of the user account, the system may determine if the PAN number matches an existing card already stored on the server, to either create a new account or leave the existing one. If a new card is created, the system may store the track data in a payment section of MST's secure memory encrypted.

The MST 102 has the ability to load any type of magnetic stripe card into the memory means, not just payment cards. Non-payment cards maybe stored separately with less security for convenience. For example, some non-payment applications may include cards to open doors, loyalty cards, etc. The loading of payment data vs. non-payment data may be separated into two separate fields or storage areas. In an example, payment cards may not be loaded into non-payment storage. For example, payment data may have a specific format that can be detected and may not be allowed to be loaded into the non-payment storage area. The payment cards may also require authentication with the application before being transmitted. On the other hand, default non-payment data may be transmitted without authentication.

The devices, systems, and methods disclosed herein provide for the magnetic card track data to be captured and stored in the MST's secure memory means directly by the user without modification, and to be used later with a POS or other MSR device. The unique binding of a MST to a specific user account such that the MST can be only used with that account for track data storage and transmission use provides better security.

The MST is capable of connecting to mobile communication devices via different interfaces beyond audio jack and USB connections. The devices, systems, and methods allow for the loading of encrypted magnetic stripe track data into the memory means of the MST that can later be decrypted and transmitted to the POS, or can be transmitted encrypted to the mobile communication device and then routed to the payment server for decryption and processing for loading a user account on the server or processing a POS transaction. The devices, systems, and methods provide for the ability to use the stored track data or swiped track data for virtual checkout environments for a more secure and lower cost transaction for merchants. The devices, systems, and methods provide for the remote loading and transmission of track data from a card issuer to the wallet server provider, to the wallet application on the mobile communication device, and to the SE or memory means of the MST for later use. The devices, systems, and methods also provide for the ability to load loyalty account information along with the payment card data into one or more discretionary fields of the track data to be read by the issuer during or after a transaction, which can lead to offers and loyalty programs combined with a payment transaction.

The mobile communication device may be a laptop computer, acellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

While “binding” is discussed herein effectively as a pairing of device to account, those skilled in the art should appreciate that in addition to one-to-one binding, one-to-many binding may be effected according to the disclosure. That is one specific user device/MST may be bound to one or more specific, owned accounts, or one account may be bound to one or more specific, owned devices.”

Although the devices, systems, and methods have been described and illustrated in connection with certain embodiments, many variations and modifications will be evident to those skilled in the art and may be made without departing from the spirit and scope of the disclosure. The discourse is thus not to be limited to the precise details of methodology or construction set forth above as such variations and modification are intended to be included within the scope of the disclosure.

1. A method of binding a user device to a user account, comprising:
sending, by the user device, a binding challenge including an indication to initiate binding including a first random number to a magnetic stripe transporter (MST);
receiving, by the user device, a response comprising the first random number, a second random number generated by the MST, and a unique identifier of the MST from the MST;
sending, by the user device, a binding request to a server, the binding request including authentication information identifying an account of a user, the second random number, and the unique identifier;
receiving, by the user device, a binding token from the server in response to the binding request, the binding token including personal identification information set for the account and a number matching the second random number, the binding token signed using a key corresponding to the MST as identified by the unique identifier;
sending, by the user device, the binding token to the MST for use in binding the MST to the user account; and
in response to financial transaction request from the user, controlling the MST bound with the account to transmit information using a magnetic field transmitter of the MST to a magnetic stripe reader (MSR) based on authentication for the MST using the personal identification information, wherein the authentication is performed on a per message basis based on the personal identification information.

2-3. (canceled)

4. The method of claim 1, wherein the sending the binding request includes sending a username, password, and the identification and the random number corresponding to the MST.

5. The method of claim 1, wherein the receiving the binding token includes receiving the second random number corresponding to the MST, a server generated time-stamp, and a personal identification number.

6. A method of binding a magnetic stripe transporter (MST) device to a user account, comprising:
receiving a binding challenge including an indication to initiate binding including a first random number from a user device;
generating a second random number;
sending a response to the binding challenge comprising the first random number, the second random number, and a unique identifier of the MST device to the user device;
receiving a binding token generated by a server from the user device, the binding token including personal identification information set for the account and a number matching the second random number, the binding token signed using a key corresponding to the MST device as identified by the unique identifier;
verifying the binding token;
binding the device to the user account in response to the verification of the binding token; and
in response to receiving a financial transaction request from the user device, transmitting information using a magnetic field transmitter of the MST device to a magnetic stripe reader (MSR) based on authentication for the MST device using the personal identification information, wherein the authentication is performed on a per message basis based on the personal identification information.

7-8. (canceled)

9. The method of claim 6, wherein the receiving the binding token includes receiving the random number corresponding to the MST device, a server generated time-stamp, and a personal identification number.

10. The method of claim 9, wherein the verifying the binding token includes matching the second random number corresponding to the MST device received by the MST device.

11. The method of claim 10, wherein the binding the MST device to the user account includes installing the personal identification number.

12-21. (canceled)

22. A mobile device, comprising:
a first modem configured to communicate with a server over a network;
a second modem configured to wirelessly communicate with a magnetic stripe transporter (MST); and
a processor configured to:
send a query including a first random number to the MST,
receive a response to the query from the MST, the response comprising a second random number generated by the MST and a unique identifier of the MST,
send a binding request to the server, the binding request including authentication information identifying an account of a user, the second random number, and the unique identifier,
receive a binding token from the server in response to the binding request, the binding token including personal identification information set for the account and a number matching the second random number, the binding token signed using a key corresponding to the MST as identified by the unique identifier,
send the binding token to the MST to bind the account to the MST, and
in response to financial transaction request from the user, control the MST bound with the account to transmit information using a magnetic field transmitter of the MST to a magnetic stripe reader (MSR) based on authentication for the MST using the personal identification information, wherein the authentication is performed on a per message basis based on the personal identification information.

23. The device of claim 22,
wherein the processor is further configured to:
generate the first random number, wherein the query includes an indication to initiate binding that includes the first random number, and
wherein the response to the query includes a signature based on the first random number, and the processor is further configured to verify the signature after receiving the response.

24. The device of claim 22, wherein the authentication information includes a username of the account and a password of the account.

25. The device of claim 22, wherein the binding token further includes a server generated time-stamp.
